(19) United States
(12) Patent Application Publication
(10) Pub. No.: US 2026/0077630 A1
(43) Pub. Date: Mar. 19, 2026

(54) MOTORIZED HVAC VENT SYSTEM

(71) Applicant: UUSI, LLC, Reed City, MI (US)

(72) Inventors: Bradley D. Looy, Big Rapids, MI (US); Richard L. Felicioni, Ada, MI (US); David W. Shank, Hersey, MI (US)

(21) Appl. No.: 19/402,862

(22) Filed: Nov. 26, 2025

Related U.S. Application Data
(63) Continuation-in-part of application No. 17/963,758, filed on Oct. 11, 2022, now Pat. No. 12,502,931.
Application No. 17/963,758 is a continuation-in-part of application No. 17/952,736, filed on Sep. 26, 2022, now Pat. No. 12,479,268.
(60) Provisional application No. 63/254,003, filed on Oct. 8, 2021.

(51) Int. Cl. B60H 1/00

(52) U.S. Cl. CPC B60H 1/00871; B60H 1/0073; B60H 1/00742; B60H 1/00771

(57) ABSTRACT

A system and method for controlling an HVAC system of a vehicle including at least one motor to move a plurality of air louvers of at least one HVAC vent of the HVAC system, a position and motion control system for controlling the at least one motor, and one or more sensors to detect hot/cold areas and send information on the detected hot/cold areas to the position and motion control system, wherein the position and motion control system receives the data from the one or more sensors to automatically determine a targeted positioning of airflow based on hot/cold areas of a vehicle cabin and dynamically change a temperature and flow of air from the at least one HVAC vent.

### CROSS REFERENCE TO RELATED APPLICATION(S)

This application is a continuation-in-part and claims the benefit of U.S. patent application Ser. No. 17/963,758, filed Oct. 11, 2022, which is a continuation-in-part and claims the benefit of U.S. patent application Ser. No. 17/952,736, filed on Sep. 26, 2022 (now U.S. Pat. No. 12,479,268, issued Nov. 25, 2025), which claims the benefit of U.S. Provisional Patent Application No. 63/254,003, filed on Oct. 8, 2021, the disclosures of all are expressly hereby incorporated by reference.

### BACKGROUND OF THE INVENTION

### 1. Field of the Invention

The present invention relates generally to HVAC systems for vehicles and, more particularly to, systems and methods for controlling motorized vents in an HVAC system for a vehicle and communications methods for sending and receiving data.

### 2. Description of the Related Art

A vehicle, such as an automobile, truck, boat, and the like, typically includes one or more user interfaces accessible by occupants such as an operator and passengers for displaying information. A user interface may also include one or more inputs that an occupant uses, or the vehicle uses, to sense and control a vehicle function or accessory like an HVAC system, a radio, a navigation system, or a phone. A user interface may also be used to control vehicle systems from portable accessories like a mobile phone or tablet.

In various types of vehicles, a user interface, such as a center stack console, is accessible to the operator and front seat passengers. The center stack has user interfaces for many vehicle functions and may include switches, knobs, light indicators, displays including touch sensitive displays, and the like. Other areas of a vehicle that may have user interfaces for sensing, control, and/or information display include overhead consoles where sunroof and interior lighting controls may be placed and rear seat controls for temperature control, entertainment systems, and the like. The particular type of user interface and its location may vary depending on the type of information displayed or accessory being controlled across a wide variety of applications.

Accordingly, it is desirable to provide a control for a motorized HVAC vent system. It is also desirable to provide a system for controlling motorized vents in an HVAC system. Therefore, there is a need in the art to provide a motorized vent control system for an HVAC of a vehicle.

### SUMMARY OF THE INVENTION

Accordingly, the present invention provides a system and method for controlling motorized vents in an HVAC system of a vehicle.

The present invention also provides a system for controlling an HVAC system of a vehicle including at least one motor to move a plurality of air louvers of at least one HVAC vent of the HVAC system, a position and motion control system for controlling the at least one motor, and one or more sensors to detect hot/cold areas and send information on the detected hot/cold areas to the position and motion control system, wherein the position and motion control system is adapted to communicate with the one or more sensors to obtain data from the one or more sensors, and wherein the position and motion control system receives the data from the one or more sensors to automatically determine a targeted positioning of airflow based on hot/cold areas of a vehicle cabin and dynamically change a temperature and flow of air from the at least one HVAC vent.

The present invention further provides a method for controlling an HVAC system of a vehicle including steps of moving, by at least one motor, a plurality of air louvers of at least one HVAC vent of the HVAC system, controlling, by a position and motion control system, the at least one motor, and detecting, by one or more sensors, hot/cold areas and sending information on the detected hot/cold areas to the position and motion control system, wherein the position and motion control system is adapted to communicate with the one or more sensors to obtain data from the one or more sensors, and wherein the position and motion control system receives the data from the one or more sensors to automatically determine a targeted positioning of airflow based on hot/cold areas of a vehicle cabin and dynamically change a temperature and flow of air from the at least one HVAC vent.

In addition, the present invention provides a method for controlling motorized vents of an HVAC system of a vehicle including steps of moving at least one motor to move air louvers of an HVAC vent of the HVAC system, controlling, by a position and motion control, movement of the at least one motor, and detecting, by one or more sensors, hot/cold areas and sending information on the detected hot/cold areas to the position and motion control, wherein the position and motion control determines a targeted positioning of airflow based on hot/cold areas; and wherein the position and motion control automatically initiates movement of air louvers.

In one embodiment, the present invention provides a system including a user interface system that incorporates a mechanism to control various functions and aspects of an HVAC system such as setting a desired temperature setting, fan speed, vent selection like left, center, and/or right, and location like floor, dash, or defrost positions.

These and other objects, advantages, and features of the present invention will become better understood from the following detailed description of one exemplary embodiment of the present invention that is described in conjunction with the accompanying drawings.

### BRIEF DESCRIPTION OF THE DRAWINGS

FIG. 1 is a diagrammatic view of a system, in accordance with one embodiment of the present invention, for controlling motorized vents in an HVAC system having a user interface and sensor inputs that may be used to control a vehicle accessory.

FIG. 2 is a diagrammatic view of a system, in accordance with one embodiment of the present invention, for controlling motorized vents in an HVAC system having a user interface and sensor inputs that may be used to control a vehicle accessory.

FIG. 3 is a diagrammatic view illustrating one configuration of the system for powering and controlling louver motors in a vehicle HVAC vent system in accordance with an embodiment of the present invention.

FIG. 4 is a diagrammatic view illustrating another configuration of the system for power and controlling louver and damper motors in a vehicle HVAC vent system in accordance with another embodiment of the present invention.

FIG. 5 is a diagrammatic view illustrating a configuration of the system for powering and controlling louver and damper motors in a vehicle HVAC vent system in accordance with another embodiment of the present invention.

FIG. 6 is a diagrammatic view illustrating a configuration of an HVAC system having three (3) motors on an HVAC vent, each motor having an analog position signal.

FIG. 7 is a top view illustrating a centered position of louvers for an HVAC vent of the HVAC system.

FIG. 8 is a top view illustrating louvers for an HVAC vent of the HVAC system positioned such that airflow is split at a center, half going left with the other half going right.

FIG. 9 is a top view illustrating louvers for an HVAC vent of the HVAC system positioned such that airflow is focused toward a center position.

FIG. 10 is a top view illustrating louvers for an HVAC vent of the HVAC system positioned such that airflow is fanned out evenly from a left side to a right side.

FIG. 11 is similar to FIG. 8 but illustrating a pivot point at an end of the louvers instead of midway.

### DESCRIPTION OF THE PREFERRED EMBODIMENT(S)

One embodiment of the present invention employs a user interface to input a desired temperature setting, fan speed, vent selection and position, and location like floor, dash, or defrost positions. The user interface devices, according to the present invention, may be used to advantage in a wide variety of applications. In vehicle applications, for example, touch sensitive user interface devices facilitate interaction with the vehicle by a mechanism of a touch screen display, by various vehicle trim components with active touch areas, as well as knobs, switches, and the like. The vehicle user may also send and receive commands and information to and from the vehicle via a mobile device such as a phone or a tablet.

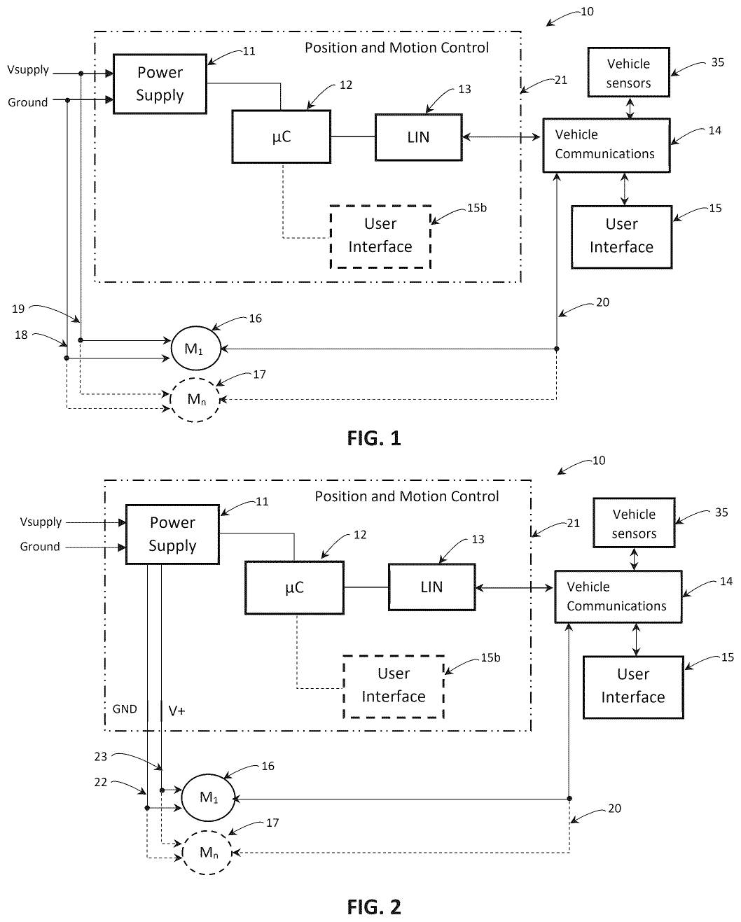

Referring to the drawings, and in particular FIG. 1, a block diagram illustrating one embodiment of a system 10, according to the present invention, is shown including a user interface 15 that provides a mechanism for a user to input data such as what radio station to listen to, what volume to play music, an HVAC temperature setpoint, a fan speed, and the like. The user interface 15 may be used to control one or more vehicle functions and vehicle accessories. The system 10 also includes vehicle communications 14 communicating with the user interface 15 and one or more vehicle sensors 35 and provides a capability or mechanism to obtain data from at least one of the vehicle sensors 35 or transfer data to another control. The system 10 includes functions that create a position and motion control 21. The position and motion control 21 includes a power supply 11, microcontroller (μC) 12, LIN communications 13, and an optional user interface 15b that may replace, or be additional to, the user interface 15. It should be appreciated that the position and motion control 21 is illustrated using LIN communications 13 protocol but may use other communications protocols such as CAN or other advantageous method.

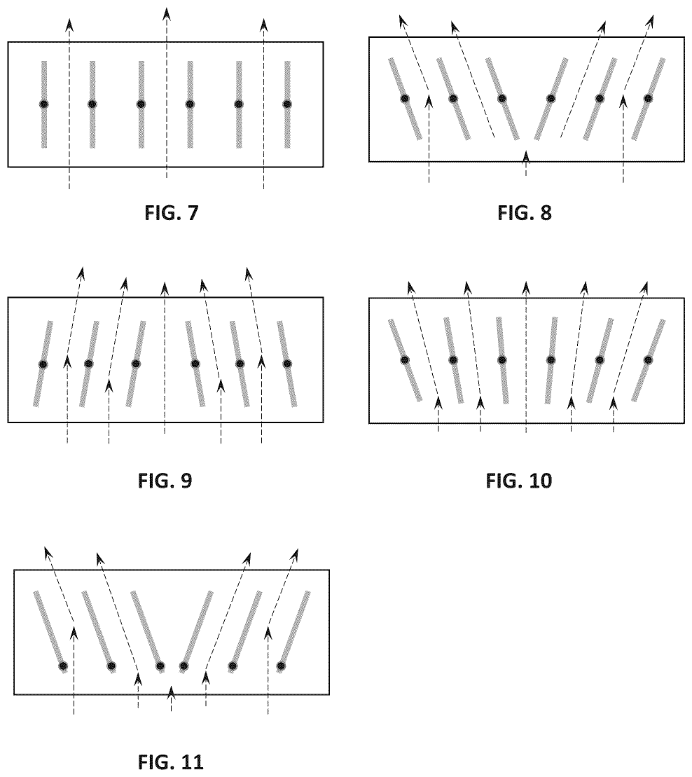

In one embodiment, the system 10 also includes at least one motor 16 that controls the position of a louver or vane (See FIGS. 7-11) of an HVAC vent. The at least one motor 16 has integral electronics that can interpret communications instructions from the vehicle communications 14. The at least one motor 16 is powered via Vsupply 19 and Ground 18 of the vehicle and is connected to the vehicle communication 14 via a connection mechanism 20. The at least one motor 16 receives instructions from the vehicle as to what position the at least one motor 16 should move or rotate to. For example, the microcontroller 12 of the position and motion control 21 receives input from the user interface 15 and, as a result, sends a command via the vehicle communications 14 to the at least one of motor 16 to rotate, for example, 25° in the clockwise direction. It should be appreciated that the at least one motor 16 interprets the communications instruction and rotates the proper amount and direction.

Referring to FIG. 2, in another embodiment of the system 10 of FIG. 1, power is supplied to the at least one motor 16 from the power supply 11 of the position and motion control 21 instead of direct connection to the vehicle power source. The power and ground are supplied via connections V+ 23 and GND 22. In some circumstances, it may be required to power the motors 16, 17 for the air louvers of the HVAC vent from the position and motion control 21 to provide a voltage that is not available or not regulated appropriately when connected directly to the vehicle. It should be appreciated that powering the motors 16, 17 directly from the position and motion control 21 also allows for drive electronics to be in the position and motion control 21 instead of integrated into each motor 16, 17.

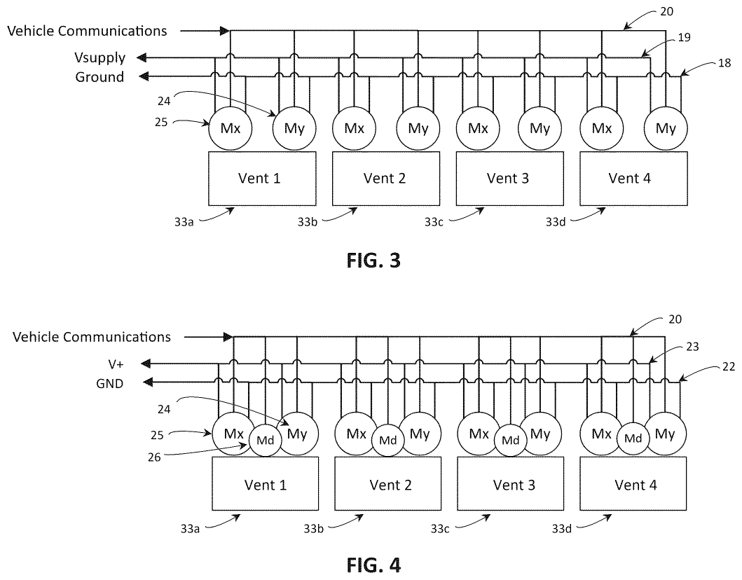

Referring now to FIG. 3, the system 10 may include a plurality of motors to accomplish various tasks. For example, in one embodiment, the system 10 may include two (2) motors attached to each HVAC vent in a dashboard of the vehicle. In one embodiment, a first motor 24 moves the air louvers or vanes in the y axis or up and down and a second motor 25 on each HVAC vent would move the air louvers or vanes in the x axis or left and right. With four (4) vents 33a-33d on a dashboard of a vehicle, for example, there would be eight (8) motors total. As illustrated, the first motor 24 shown as MY moves the air louvers directing airflow up and down and the second motor 25 shown as MX moves air louvers that direct airflow left and right. In another embodiment shown in FIG. 4, the system 10 may include a third motor 26 that controls the amount of airflow from no airflow to full airflow by moving a damper in the HVAC vent.

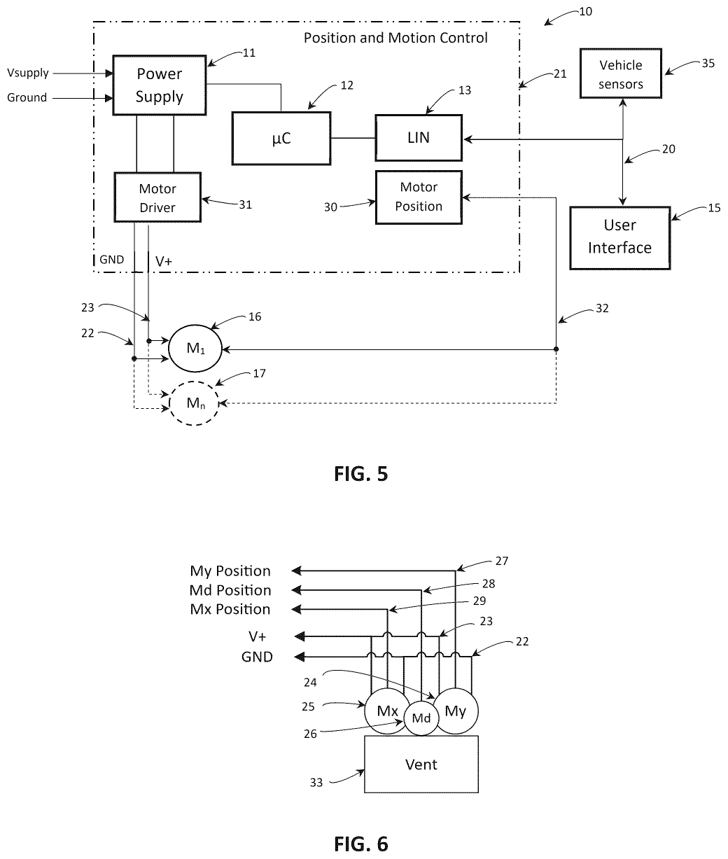

The system 10 of FIG. 5 is similar to the system 10 of FIG. 2 with the exception that the position and motion control 21 has a motor position 30 function as well as a motor driver 31 function. The motor position 30 takes the voltages 32 from each of the motors 16, 17 and interprets them to determine the position of each motor 16, 17. By knowing where each motor is, the position and motion control 21 can drive each motor to a desired location by employing the motor driver 31. It should be appreciated that the motor driver 31 provides proper voltages to energize each motor 16, 17 to drive it to a desired position.

Referring to FIG. 6 with continual reference to FIGS. 4 and 5, another embodiment is shown which includes the motors 24, 25, and 26 that move the air louvers and a damper in an HVAC vent 33. Each of the motors 24, 25, and 26 includes an analog output voltage that represents its physical position. The motor 25 (Motor Mx) that positions the air louvers of the HVAC vent 33 in the x-axis or left and right, has an output 29 that provides a voltage that represents where in the full left to right range the louvers are currently positioned. For example, if the motor 25 is in the full left position, the output voltage on Mx position output 29 could be zero (0) volts. And if motor 25 is in the full right position, the output voltage on Mx position output 29 could be five (5) volts. So, if the position and motion control 21 energizes the motor 25 such that the air louvers are in the middle of its range, an output voltage of 2.5 volts would be present on Mx position output 29. It should be appreciated that the same holds true for the motor 24 (My) with output voltage 27 and the motor 26 (Md) with output voltage 28 whereas instead of left to right or up and down positioning, the motor 26 will travel from the damper full closed position to a damper fully open position.

Referring to FIG. 5, the system 10 includes the vehicle sensors 35 that send information to the position and motion control 21. The vehicle sensors 35 may include thermal sensors such as a thermal camera or discrete temperature sensors. By using thermal sensors, it is possible for the system 10 to determine hot/cold areas of the vehicle cabin. It should be appreciated that, with this information, the HVAC vent 33 could be directed to provide airflow to specific areas by changing the louver position of the HVAC vent 33 and airflow with the goal being to homogenize the temperature throughout the vehicle cabin.

As previously discussed, the system 10 provides the mechanism to move air louvers and damper of the HVAC vent 33 to a desired position. The system 10 may include an oscillating function that will cyclically move the air louvers back and forth in a side to side and/or up and down motion to provide airflow across a predetermined path. This allows for air movement in the vehicle cabin to help homogenize the temperature as well as limiting the time spent in any one direction. For example, an operator may want air to blow on them, but not all the time, which would cause discomfort because the operator would get too cold or too warm. The vehicle cabin may still be too cold/warm, but the operator becomes uncomfortable because air is blowing on them all the time. It should be appreciated that providing oscillatory airflow will allow the vehicle cabin to come to a desired temperature, and maintain that desired temperature, while minimizing operator discomfort.

Further, the system 10 may include intelligence that could be employed by using the vehicle sensors 35 such as a thermal imaging device. The thermal image gathered from the thermal imaging device can be analyzed to determine where an occupant is located, and specifically where their face is located. If an operator's face location is known, the system 10 can cause the air louvers of the HVAC vent 33 can oscillate back and forth and move up and down to avoid direct airflow to their face. Similarly, the air louvers of the HVAC vent 33 can oscillate back and forth to direct airflow, but the damper could be used to slow or stop the airflow to avoid or slow the blowing of air directly on the occupant. An added function that could be employed is to use the thermal imaging camera image to analyze and determine the relative temperature of an individual. For example, if the thermal image reveals that the individual's overall temperature or portions thereof are too warm or cold to expect reasonable comfort, the HVAC vents could be controlled to provide air on the targeted areas at an appropriate temperature to help achieve an individual's comfort. Another added function would be to employ and analyze the thermal image of individuals to make an assessment if the individual is likely to have a fever. It should be appreciated that the system 10 may employ a standard camera instead of, or in addition to, a thermal imaging camera, to find an operator's face to avoid direct airflow to the operator's face.

In one embodiment, the vehicle sensors 35 may include occupancy sensors that provide information to the vehicle about whether a seat is occupied or not. This function has been typically used for turning on the airbag function or as a rear seat reminder that a child is present. However, occupancy sensing can also be employed by the system 10. If a seat, such as for a front passenger is empty, the two HVAC vents typically associated with the passenger position could be closed by energizing the damper motor 26 Md. It should be appreciated that closing off the HVAC vents would provide more airflow for the remaining HVAC vents that are open.

FIGS. 7-11 show various configurations of air louvers of the HVAC vent 33 that can be employed to change air direction as needed to accomplish homogeneity in air temperature while conforming to user defined flow paths. FIG. 7 shows a standard configuration with the air louvers providing straight through airflow. FIG. 8 shows diverging air louvers to split airflow to the left and right as it exits the HVAC vent 33. FIG. 9 shows converging air louvers to focus airflow into a concentrated flow path. FIG. 10 shows an even diverging airflow path, and FIG. 11 shows a diverging air louvers pattern, but with the air louvers pivoting from an end instead of a centrally located pivot point. It should be appreciated that, while the examples shown in FIGS. 7-11 are symmetrical about a centerline, they could be non-symmetrical in any advantageous form.

The HVAC vents can be controlled such that airflow, direction and temperature, can be controlled automatically to maintain a desired environment to ensure occupant comfort. For example, HVAC airflow, direction, and temperature can be dynamically controlled without occupant interaction, based on the sun load on the vehicle. If there is direct sunlight coming in the passenger side of the vehicle, airflow can be enhanced on the passenger side to help even out vehicle cabin temperature. Likewise, if the sun is coming in the front or the back of the vehicle, airflow temperature and speed can be automatically changed to provide more or less air to the front or back of the vehicle. By dynamically changing the temperature and flow of air from the HVAC vents, the temperature can be modified quickly. When there are intermittent sun and shade on the vehicle such as on a partly cloudy day, the system 10 can automatically compensate by raising or lowering the temperature and/or speed of the airflow as well as control vent louver position. As previously described, sensors such as sun load sensors, thermal sensors, and/or thermal images can be used singly or in combination to provide information to the system 10 to ensure a consistent and homogeneous environment.

If each HVAC vent 33 has controllable air louvers and dampers to control air direction and flow, the HVAC vents 33 can be adjusted to a user preferred location. For example, if vehicle operator #1 approaches the vehicle with a key fob, the vehicle recognizes the key fob as that of operator #1 and adjusts the air direction and flow to what the operator #1 had previously set the HVAC vents 33 to. It should be appreciated that, likewise, if vehicle operator #2 approaches the vehicle with their key fob, the vehicle will adjust HVAC parameters to what they previously had.

All vent positions may also be controlled remotely via a mobile device such as a phone or tablet. As vehicles become more and more automatic on the way to fully autonomous, a further benefit in the exemplary embodiment of the present invention is obtained by the use of a remote device. A vehicle operator may summon their car from the parking lot or their garage to come and pick them up at some location. The mobile device will send out the appropriate commands for the vehicle to start moving toward the operator. The mobile device, having unique ID numbers like the IMEI number, identifies to the vehicle which operator is commanding it to move. It should be appreciated that, as such, the vehicle can adjust all HVAC parameters including vent position and flow, as well as seat position, mirror position, and other parameters.

In addition to temperature, humidity control can also be employed. On days where the air is too dry or humid such that it may become uncomfortable for a person, humidity may be added to, or removed from, the airflow to improve comfort level.

In another exemplary embodiment, the system 10 can not only be used as previously described changing air direction, speed, and temperature, but can also be expanded to provide means of changing and/or augmenting the cabin space environment.

There is ongoing research to sense and use bio-signal recognition to adapt an environment to the mood of a person. For example, automaker KIA and Massachusetts Institute of Technology (MIT) are collaborating to develop technologies that will provide data to control systems that will change environmental factors to meet or alter the mood of individuals. The system 10 includes features that change the overall vehicle occupant environment such that psychological aspects, such as mood, anxiety, stress, and the like, can be modified to improve the well-being of the occupants.

Examples of environmental conditions and/or aspects that can be used include, smell, lighting, sound, temperature, humidity, oxygen content, and outside air intake. If the system 10 senses drowsiness in the driver, vehicle cabin temperature may be lowered, or oxygen could be added to the vehicle cabin air to help increase the driver's alertness. If anxiety or tension is sensed, calming scents could be introduced into the HVAC system, soothing music could play, or noise cancellation employed, lighting may be adjusted, all being done to modify how the occupants feel and improve occupant well-being.

The system 10 can sense and modify other aspects of the vehicle cabin environment such as air quality. Oxygen and/or carbon dioxide gases can be sensed and altered by oxygen insertion or by increasing make-up (outside) air percentage. Air cleanliness can also be sensed and altered by use of a particulate sensor and air filters. If there is a high particle count, such as during high pollen seasons, air filtration can be accomplished by reducing air make-up percentage or by increasing airflow through a filtration system. A filtration system can include pass-through filters or electrostatic cleaners. Air can also be cleaned of bacteria and virus presence by use of UV lighting in an air-flow path.

It should be appreciated that the functions and features listed in the embodiments of the system 10 described above can also be used in a home environment. Home automation implementation is increasing rapidly in many forms including lighting, temperature, window treatment control, and music, as examples. Many home functions can be controlled to provide an environment that will improve the well-being of the occupants. Functions like those mentioned have been integrated into home automation controllers so that computers and mobile devices like phones, tablets, and watches can control their operation. Operation control includes on/off, volume of sound, open/closed, lighting brightness, and the like. Detailed control of home functions provides an immersive environment for the occupant to live. HVAC functions can be controlled to provide even temperature throughout the home or individual rooms/areas at different preferred temperatures. It should be appreciated that air vents/registers can be controllable such that the air can be directed in a desired direction or oscillatory so that there is movement of air over a larger area.

In another embodiment, the system 10 incorporates predictive control algorithms that analyze historical user HVAC preferences, cabin thermal behavior, sun-load patterns, and occupant-specific comfort tendencies to anticipate required adjustments before temperature deviations occur. Such predictive algorithms may be executed locally within the position and motion control 21 or remotely via a cloud-connected server, allowing the system 10 to pre-position louvers, adjust damper states, or modify airflow rates based on expected environmental changes. It should be appreciated that predictive control reduces energy consumption and improves comfort by minimizing reactive system behavior and enabling proactive airflow distribution.

In yet another embodiment, the system 10 includes a vehicle-to-infrastructure (V2I) communication system for receiving environmental and situational data from external sources. Such data may include outside temperature, humidity, solar irradiance, air pollution levels, pollen count, or localized weather alerts. The position and motion control 21 processes this data or information in real time using predictive machine learning models that correlate historical HVAC responses with anticipated environmental conditions. For instance, a supervised learning model trained on prior vehicle and environmental interactions can predict the optimal airflow distribution, vent positioning, and temperature settings for upcoming roadway conditions, allowing proactive adjustment before occupants experience discomfort.

In a further embodiment, reinforcement learning algorithms are employed to continuously refine HVAC control strategies based on feedback from both in-cabin sensors and external environmental data. The system 10 may compare predicted occupant comfort outcomes with real-time measurements—such as thermal sensor readings, CO₂ levels, and biometric signals from wearable devices—and adjust its predictive model weights accordingly. It should be appreciated that, over time, this adaptive learning approach enables the system 10 to optimize ventilation patterns, filtration rates, and airflow direction not only for standard environmental conditions but also for atypical scenarios such as sudden sun glare, rapid temperature changes, or localized pollution events, effectively creating a self-tuning climate management system.

In an additional embodiment, the system 10 may include anomaly detection models to monitor V2I data streams for unexpected environmental changes or sensor inconsistencies. Techniques such as Autoencoder-Based Anomaly Detection or Isolation Forest algorithms can identify irregular patterns in incoming weather alerts, pollution spikes, or temperature deviations, triggering proactive interventions in vent actuation and HVAC settings. It should be appreciated that, by integrating anomaly detection with predictive machine learning, the system 10 ensures that airflow, temperature, and filtration adjustments are anticipatory rather than purely reactive, providing enhanced occupant comfort, improved air quality, and robust adaptability to rapidly changing environmental conditions.

In a further embodiment, the system 10 integrates a broad array of biometric sensing technologies beyond thermal or optical imaging, including but not limited to heart rate, heart rate variability (HRV), respiration rate, pupil dilation tracking, galvanic skin response, skin temperature, and micro-movement detection. These biometric inputs may originate from onboard vehicle sensors or from personal wearable devices such as smart watches, health-monitoring rings, fitness bands, or biometric bracelets paired wirelessly with the vehicle. When combined, these physiological signals provide a continuous data stream reflecting occupant stress, fatigue, alertness, thermoregulatory response, and overall comfort state. It should be appreciated that the system 10 aggregates and preprocesses this data to create a real-time occupant physiological profile that is more comprehensive than cabin-based sensing alone.

In one implementation, machine learning models—including supervised learning classifiers, time-series forecasting networks, and anomaly-detection algorithms—are employed to interpret the biometric data and correlate it with environmental stimuli, historical occupant behavior, and prior HVAC system responses. The models may learn individualized patterns such as how a specific occupant's heart rate or skin conductance changes under direct airflow, elevated cabin temperature, or prolonged sun exposure. The system 10 may further infer latent physiological states such as early-stage fatigue, elevated stress, thermoregulatory overload, or discomfort trends not detectable by conventional threshold-based logic. It should be appreciated that, by analyzing multi-modal sensor fusion data, the machine learning models continuously improve accuracy over time, generating predictive insights that allow the system 10 to react earlier and more precisely than reactive or rule-based controllers.

Based on these AI-derived inferences, the position and motion control 21 dynamically adjusts HVAC vent operation—including airflow temperature, velocity, distribution patterns, oscillation frequency, humidity modulation, outside-air intake, and micro-climate zoning—to proactively stabilize occupant comfort and physiological wellbeing. For example, if the system 10 detects signs of rising stress through biometric wearables, the system 10 may initiate a gradual cooling airflow pattern with minimal acoustic disturbance; if signs of fatigue are detected, the system 10 may increase fresh-air intake or provide a subtle dynamic airflow pattern designed to promote alertness. It should be appreciated that this combination of biometric integration, wearable-sourced physiological sensing, and machine learning inference enables a highly individualized adaptive comfort system that extends beyond traditional HVAC control, offering meaningful improvements in occupant health, wellbeing, and personalized environmental management.

In another embodiment, system 10 includes enhanced noise-adaptive airflow control wherein the system 21 automatically modifies airflow velocity and louver positions to minimize perceived noise inside the cabin. The system 10 may include cabin microphones to detect airflow noise signatures and dynamically reduce or redirect airflow to maintain occupant comfort while reducing acoustic disturbance. It should be appreciated that such noise-adaptive control is particularly beneficial during hands-free phone calls, autonomous driving modes, or relaxation-oriented cabin states.

In yet another embodiment, the system 10 includes coordinated multi-zone airflow choreography using artificial intelligence and machine learning models to optimize comfort and physiological effects. The machine learning models, such as reinforcement learning agents or recurrent neural networks, may analyze historical occupant interactions, biometric feedback, and environmental data to determine optimal timing, intensity, and direction of airflow across multiple vents 33a-33d. It should be appreciated that the position and motion control 21 uses these models to generate adaptive, predictive airflow sequences that adjust dynamically in real-time based on occupant location, activity level, and detected thermal comfort preferences.

The system 10 also includes supervised learning algorithms to classify occupant states, such as drowsiness, stress, or elevated body temperature, using inputs from biometric devices such as smartwatches, rings, or bracelets that provide heart rate, respiration rate, or skin conductance data. The machine learning models can then modulate the multi-zone airflow choreography to promote alertness, relaxation, or cooling/heating in specific zones. For example, if elevated stress levels are detected in a rear-seat passenger, the system 10 may increase gentle oscillating airflow to that area while maintaining overall cabin temperature homogeneity, thereby enhancing individualized comfort without manual adjustment.

Further, the system 10 may include reinforcement learning-based optimization to continuously refine multi-zone airflow choreography over time. By evaluating occupant feedback, environmental conditions, and energy efficiency metrics, the system 10 can identify airflow sequences that maximize both comfort and HVAC system efficiency. The AI-enabled choreography may include coordinated wave-like patterns, alternating directional cooling pulses, or rotational airflow effects that are automatically customized per occupant or vehicle mode, providing a highly personalized and energy-efficient cabin environment that adapts proactively to occupant needs.

In a further embodiment, the vehicle-to-infrastructure (V2I) communication system enhances predictive multi-zone airflow choreography. Environmental data, such as outside temperature, humidity, pollution levels, and weather alerts, can be processed by machine learning models to anticipate changes in cabin comfort requirements. The position and motion control 21 proactively adjusts vent positions, airflow intensity, and sequencing patterns before the vehicle encounters extreme weather conditions, high sunlight exposure, or poor air quality. It should be appreciated that, by combining occupant biometric feedback, historical preferences, and predictive V2I inputs, the system 10 can generate dynamic, preemptive airflow sequences that optimize comfort, alertness, and air quality, while simultaneously improving energy efficiency and occupant wellbeing.

In an additional embodiment, the position and motion control 21 may employ one or more machine learning models that continually learn occupant comfort preferences, environmental behavior, and vehicle-specific thermal dynamics. The machine learning models may be trained using inputs such as user adjustments, historical HVAC behavior, thermal imaging data, sun load measurements, humidity levels, air quality indicators, occupancy detection, and cabin geometry characteristics. Over time, this enables the system 10 to form an evolving representation of how the vehicle cabin responds to environmental conditions and how individual occupants prefer airflow, temperature, and vent positioning. It should be appreciated that this learned representation allows the system 10 to automatically tailor airflow direction, oscillation behavior, and temperature output with a level of precision unattainable by fixed-rule systems.

Traditional closed-loop logic systems—such as PID controllers, bang-bang control, threshold-based logic, or lookup-table-driven responses—typically operate by reacting to instantaneous sensor feedback and comparing it to predefined setpoints. These systems are inherently limited because they do not incorporate historical data, contextual cues, or predictive insights. They respond only after a deviation occurs, and adjustments are often fixed, rigid, or unable to account for complex multi-variable relationships. In contrast, the machine learning model may evaluate long-term trends and correlations between variables such as ambient temperature, solar trajectory, vehicle speed, occupant habits, and the rate at which the cabin naturally gains or loses heat. As a result, the system 10 can perform anticipatory adjustments—such as repositioning louvers before a predicted temperature imbalance occurs—rather than relying solely on reactive corrections after discomfort has already begun.

The machine learning model may also outperform conventional systems by recognizing non-linear thermal behaviors and localized heating or cooling patterns that arise from unique cabin geometries, material reflectivity, occupant positioning, or vent configuration. For example, the model may learn that during afternoon driving, the passenger-side dashboard consistently heats more rapidly due to sun exposure, requiring earlier airflow redirection even if the current temperature sensors have not yet detected a rise. Similarly, the model may identify that certain airflow paths cool the cabin faster when vehicle windows are closed versus when they are slightly open, or that micro-adjustments to louver positions reduce energy consumption while maintaining comfort. It should be appreciated that conventional closed-loop systems lack the flexibility to discover or adapt to such complex relationships because they rely on static rules defined at design time rather than learned behavior accumulated during long-term operation.

Further, the machine learning model may include predictive inference techniques to forecast future thermal conditions based on sun load trajectory, GPS location, orientation of the vehicle relative to the sun, and even anticipated weather changes. By predicting the cabin state minutes in advance, the system 10 can adjust vent direction, airflow intensity, and damper positions preemptively. It should be appreciated that this proactive capability ensures faster temperature stabilization, improved comfort, and reduced oscillation between hot and cold cycles. It should be appreciated that closed-loop systems, by contrast, typically overshoot or undershoot target temperatures due to their reactive nature and inability to model future events.

In addition, the machine learning models may substantially enhance personalization capabilities. The system 10 may learn the comfort signatures of multiple users by analyzing repeated interactions, such as how often a particular user diverts airflow away from their face, prefers indirect airflow patterns, or tolerates lower fan speeds. These behavioral patterns can be encoded into individualized comfort profiles automatically recognized when a given occupant enters the vehicle. Over time, the system 10 may refine these profiles using reinforcement-based learning derived from subtle adjustments made by users. It should be appreciated that such personalized, dynamic behavior is not possible with traditional closed-loop systems, which rely on static presets and cannot self-update based on occupant behavior.

Finally, the use of machine learning models can improve energy efficiency by minimizing unnecessary airflow or temperature changes. By predicting the minimum airflow or temperature differential required to maintain comfort, the machine learning model may reduce compressor usage, fan speed, or overall system load. The machine learning model may also selectively deactivate or close vents when historical data suggests that certain zones do not require active conditioning at particular times or under certain conditions. It should be appreciated that closed-loop control systems, lacking predictive optimization capabilities, typically run at higher duty cycles or make overly conservative adjustments, thereby consuming more energy. It should also be appreciated that the integration of machine learning models provides a superior approach to HVAC vent control by enabling predictive, context-aware, adaptive, and personalized management of airflow and temperature in a manner that closed-loop logic systems cannot achieve.

The system 10 may use GPS location and learned interactions to anticipate a user's preferred HVAC settings—for example, reducing cabin temperature by 3 degrees, increasing fan speed, and directing airflow toward the face after a gym visit. The system 10 may also receive data from a smart device such as a watch or a ring to determine heart rate and body temperature and use that data to anticipate a desired HVAC setting. The system 10 could learn and anticipate individual desires based on learning and inference from previous interactions. If there are two (or more) occupants in a vehicle, the system 10 could use biometric data from smart watches, rings, and the like from all occupants to adjust the various aspects of the HVAC system to create individual comfort zones for each occupant of the vehicle.

In another embodiment, the system 10 includes augmented reality (AR) visualization capabilities that allow occupants to view airflow patterns, temperature distribution, and vent state information via a heads-up display or mobile application. The AR interface may highlight airflow trajectories, predicted temperature balancing times, and recommended manual adjustments. It should be appreciated that AR-based feedback improves user understanding of HVAC system operation and provides enhanced control transparency.

In a further embodiment, the system 10 may use spatial audio cues to communicate airflow adjustments to occupants without requiring visual displays or manual inspection of vent positions. In this embodiment, one or more cabin speakers may generate localized, directionally distinct audio signals that correspond to specific vents or airflow zones. For example, when the system 10 modifies the position of louvers in the left-side HVAC vent 33, a subtle audio tone may be emitted from the corresponding left-side cabin speaker, thereby providing an intuitive indication of which vent has been updated. Spatial audio cues may further include variations in pitch, timbre, duration, or repetition pattern to indicate the type of adjustment being performed, such as louver rotation, oscillation initiation, damper opening, airflow modulation, or targeted micro-climate activation. The system 10 may also employ adaptive audio filtering to ensure such cues remain perceptible without being disruptive, automatically lowering cue volume during phone calls, navigation prompts, or periods of high cabin noise.

It should be appreciated that spatial audio communication enables occupants to remain informed about HVAC adjustments while maintaining focus on the driving task and without requiring attention to displays or physical vents. In particular, this approach provides significant benefits for visually impaired occupants by offering a non-visual, orientation-based method of understanding and interacting with the HVAC system. The spatialized cues allow visually impaired users to immediately determine which vent is being adjusted, how airflow patterns are changing, and whether actions such as oscillation or temperature modulation have been initiated. This affords them equivalent situational awareness to sighted users without requiring tactile confirmation or assistance from another person. Additionally, the system 10 may be configured to produce more pronounced or extended audio cues when accessibility settings are enabled, allowing visually impaired users to receive clearer, more descriptive feedback. It should be appreciated that, overall, spatial audio cueing enhances safety, improves accessibility, and ensures that all occupants—regardless of visual ability—can intuitively perceive and comprehend the system's behavior.

In another embodiment, the system 10 includes an AI-driven cabin-sanitization mode that coordinates airflow direction, damper positioning, and filtration elements to efficiently purge contaminants from the vehicle cabin. The machine learning models may analyze historical and real-time cabin air quality data, occupancy patterns, external environmental conditions, and V2I information to predict contaminant levels, such as particulate matter, volatile organic compounds (VOCs), pollen, or airborne pathogens. Based on these predictions, the position and motion control 21 may proactively adjust HVAC vent positions, airflow speeds, and filtration activation to maximize purification effectiveness while maintaining occupant comfort.

The system 10 may include reinforcement learning algorithms to dynamically optimize vent operation, louver oscillation patterns, and outside air intake to achieve rapid contaminant removal. Sensor fusion techniques may combine inputs from CO₂ sensors, VOC sensors, particulate matter sensors, UV-C or ionization status, and occupancy data to detect anomalies in air quality, triggering targeted cleaning sequences. In this manner, the system 10 adapts in real time to changing cabin and external conditions, learning which vent and airflow configurations are most effective under specific scenarios, such as high occupancy, heavy traffic, or localized pollution events.

Furthermore, biometric feedback from occupant-worn devices, such as smartwatches, rings, or bracelets, may be integrated into the AI models to enhance system responsiveness. Elevated respiration rate, skin temperature, or other physiological indicators detected by these devices may signal discomfort or potential allergen exposure, prompting the system 10 to adjust airflow, filtration, and sanitization operations accordingly. It should be appreciated that such AI-and machine learning-enhanced sanitization modes provide a proactive, adaptive, and highly personalized approach to cabin hygiene, improving occupant health, comfort, and overall wellbeing, particularly in vehicle-sharing environments, high-pollution areas, or during infectious disease seasons.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A system for controlling an HVAC system of a vehicle comprising:
at least one motor to move a plurality of air louvers of at least one HVAC vent of the HVAC system;
a position and motion control system for controlling the at least one motor;
one or more sensors to detect hot/cold areas and send information on the detected hot/cold areas to the position and motion control system;
wherein the position and motion control system is adapted to communicate with the one or more sensors to obtain data from the one or more sensors; and
wherein the position and motion control system receives the data from the one or more sensors to automatically determine a targeted positioning of airflow based on hot/cold areas of a vehicle cabin and dynamically change a temperature and flow of air from the at least one HVAC vent.

2. The system of claim 1 wherein the position and motion control system includes predictive control algorithms to analyze at least one of historical user HVAC preferences, cabin thermal behavior, sun-load patterns, and occupant-specific comfort tendencies to anticipate required adjustments before temperature deviations occur.

3. The system of claim 2 wherein the predictive control algorithms are executed locally within the position and motion control system or remotely via a cloud-connected server.

4. The system of claim 1 including a vehicle-to-infrastructure (V2I) communication system for receiving environmental and situational data from external sources.

5. The system of claim 4 wherein the data includes at least one of outside temperature, humidity, solar irradiance, air pollution levels, pollen count, and localized weather alerts.

6. The system of claim 5 wherein the position and motion control system processes the data in real time using predictive machine learning models that correlate historical HVAC responses with anticipated environmental conditions.

7. The system of claim 1 wherein the position and motion control system includes reinforcement learning algorithms to continuously refine HVAC control strategies based on feedback from both in-cabin of the one or more sensors and external environmental data.

8. The system of claim 4 wherein the position and motion control system includes anomaly detection models to monitor data streams from the V2I communication system for at least one of unexpected environmental changes and sensor inconsistencies.

9. The system of claim 1 wherein the position and motion control system includes an array of biometric sensors for sensing at least one of heart rate, heart rate variability (HRV), respiration rate, pupil dilation tracking, galvanic skin response, skin temperature, and micro-movement detection.

10. The system of claim 9 wherein the position and motion control system includes machine learning models to interpret biometric data from the biometric sensors and correlate the biometric data with at least one of environmental stimuli, historical occupant behavior, and prior HVAC system responses.

11. The system of claim 10 wherein the machine learning models include at least one of supervised learning classifiers, time-series forecasting networks, and anomaly-detection algorithms.

12. The system of claim 1 wherein the position and motion control system dynamically adjusts an operation of the at least one of HVAC vent to proactively stabilize occupant comfort and physiological wellbeing.

13. The system of claim 12 wherein the position and motion control system adjusts at least one of airflow temperature, velocity, distribution patterns, oscillation frequency, humidity modulation, outside-air intake, and micro-climate zoning.

14. The system of claim 1 wherein the position and motion control system includes enhanced noise-adaptive airflow control to automatically modify airflow velocity and louver positions of the louvers to minimize perceived noise inside the cabin.

15. The system of claim 14 including at least one cabin microphone to detect airflow noise signatures and dynamically reduce or redirect airflow to maintain occupant comfort while reducing acoustic disturbance.

16. The system of claim 1 wherein the position and motion control system includes coordinated multi-zone airflow choreography using artificial intelligence (AI) and machine learning models to optimize comfort and physiological effects.

17. The system of claim 16 wherein the machine learning models analyze at least one of historical occupant interactions, biometric feedback, and environmental data to determine optimal timing, intensity, and direction of airflow across a plurality of the at least one HVAC vent.

18. The system of claim 16 wherein the position and motion control system uses the machine learning models to generate adaptive, predictive airflow sequences that adjust dynamically in real-time based on occupant location, activity level, and detected thermal comfort preferences.

19. The system of claim 1 wherein the position and motion control system includes supervised learning algorithms to classify occupant states of at least one of drowsiness, stress, and elevated body temperature, using inputs from biometric devices such as smartwatches, rings, or bracelets that provide heart rate, respiration rate, or skin conductance data.

20. The system of claim 1 wherein the position and motion control system includes reinforcement learning-based optimization to continuously refine multi-zone airflow choreography over time.

21. The system of claim 20 wherein the position and motion control system uses AI-enabled choreography of at least one of coordinated wave-like patterns, alternating directional cooling pulses, and rotational airflow effects that are automatically customized per occupant or vehicle mode.

22. The system of claim 1 wherein the position and motion control system proactively adjusts at least one of louver positions of the louvers, airflow intensity, and sequencing patterns before the vehicle encounters extreme weather conditions, high sunlight exposure, and poor air quality.

23. The system of claim 16 wherein the machine learning models continually learn at least one of occupant comfort preferences, environmental behavior, and vehicle-specific thermal dynamics.

24. The system of claim 16 wherein the machine learning models recognize at least one of non-linear thermal behaviors and localized heating or cooling patterns that arise from at least one of cabin geometries, material reflectivity, occupant positioning, and vent configuration.

25. The system of claim 16 wherein the machine learning models include predictive inference techniques to forecast future thermal conditions based on at least one of sun load trajectory, GPS location, orientation of the vehicle relative to the sun, and anticipated weather change.

26. The system of claim 1 wherein the position and motion control system uses a GPS location of the vehicle and learned interactions to anticipate a user's preferred HVAC settings.

27. The system of claim 26 wherein the position and motion control system receives data from a smart device to determine at least one of heart rate and body temperature and uses that data to anticipate a desired HVAC setting.

28. The system of claim 27 wherein the position and motion control system learns and anticipates occupant desires based on learning and inference from previous interactions.

29. The system of claim 1 wherein the position and motion control system includes augmented reality (AR) visualization that allows occupants to view at least one of airflow patterns, temperature distribution, and vent state information of the at least one HVAC vent via either one of a heads-up display and mobile application.

30. The system of claim 1 wherein the position and motion control system uses spatial audio cues to communicate airflow adjustments to occupants without requiring visual displays or manual inspection of louver positions of the louvers.

31. The system of claim 30 including one or more cabin speakers to generate localized, directionally distinct audio signals that correspond to the at least one HVAC vent or airflow zones.

32. The system of claim 1 wherein the position and motion control system includes an AI-driven cabin-sanitization mode that coordinates at least one of airflow direction, damper positioning, and filtration elements to efficiently purge contaminants from a vehicle cabin of the vehicle.

33. The system of claim 32 wherein the position and motion control system proactively adjusts at least one of louver positions of the louvers, airflow speeds, and filtration activation to maximize purification effectiveness while maintaining occupant comfort.

34. The system of claim 32 wherein the position and motion control system includes reinforcement learning algorithms to dynamically optimize at least one of vent operation of the at least one HVAC vent, louver oscillation patterns of the louvers of the at least one HVAC vent, and outside air intake to achieve contaminant removal.

35. The system of claim 32 wherein the position and motion control system uses biometric feedback from occupant-worn devices of at least one of smartwatches, rings, and bracelets.

36. A method for controlling an HVAC system of a vehicle comprising steps of:
moving, by at least one motor, a plurality of air louvers of at least one HVAC vent of the HVAC system;
controlling, by a position and motion control system, the at least one motor; and
detecting, by one or more sensors, hot/cold areas and sending information on the detected hot/cold areas to the position and motion control system, wherein the position and motion control system is adapted to communicate with the one or more sensors to obtain data from the one or more sensors, and wherein the position and motion control system receives the data from the one or more sensors to automatically determine a targeted positioning of airflow based on hot/cold areas of a vehicle cabin and dynamically change a temperature and flow of air from the at least one HVAC vent.
